(19) United States
(12) Patent Application Publication
(10) Pub. No.: US 2013/0120280 A1
(43) Pub. Date: May 16, 2013

(54) System and Method for Evaluating Interoperability of Gesture Recognizers

(71) Applicant: Tim Kukulski, Oakland, CA (US)

(72) Inventor: Tim Kukulski, Oakland, CA (US)

(21) Appl. No.: 12/789,743

(22) Filed: May 28, 2010

(51) Int. Cl. G06F 3/041

(52) U.S. Cl. 345/173

(57) ABSTRACT

Various embodiments of a system for evaluating the usability and interoperability of touch gestures are described. A gesture test system may perform a geometric analysis of a touch gesture to determine a usability level for the gesture. A touch gesture may be represented in a gesture definition language. A touch gesture recognizer may be configured to recognize a particular touch gesture. The gesture test system may independently test the ability of a touch gesture recognizer to recognize the particular touch gesture. The gesture test system may test the interoperability of multiple touch gesture recognizers, which may be used by a software application to interpret touch gestures, to determine whether the independently developed touch gesture recognizers from different sources are likely to have conflicts which may result in misinterpretation of the gestures. Real-time test data recorded in gesture tests and independent recognizer tests may be re-used in the recognizer interoperability tests.

### BACKGROUND

Touch gesture technology provides hardware and software that allows computer users to control various software applications via the manipulation of one or more digits (e.g., finger(s) and/or thumb) on a touch-sensitive surface of a touch-enabled device. Touch gesture technology generally consists of a touch-enabled device such as a touch-sensitive display device (computer display, screen, table, wall, etc.) for a computing system (desktop, notebook, touchpad, tablet, etc.), as well as software that recognizes multiple, substantially simultaneous touch points on the surface of the touch-enabled device

Conventional graphical user interface (GUI) test systems evaluate the ability of a GUI to respond to user inputs that are received via an input pointing device, such as a cursor and a cursor control device (e.g., mouse, keyboard, or other device). The conventional GUI test systems rely on user inputs that are applied directly to graphical interface elements, or graphical objects, within the GUI. Examples of such user inputs are a mouse click applied to an icon, a mouse click and drag of a scroll bar, and a mouse selection of an item in a drop down menu. The graphical interface element to which the user input is applied provides a context for the user input. For example, a mouse click applied to an icon is interpreted differently from a mouse click applied to a menu item. A conventional evaluation of the ability of a GUI to respond to user input is dependent on the context provided by the graphical user interface elements of the GUI. The context provided by a graphical user interface element of a GUI in a conventional system also ensures that a user input is not misinterpreted as a different user input. Accordingly, a conventional GUI test system does not test the interoperability of multiple user input responses within a GUI. In addition, a conventional GUI test system, in response to the addition of a new user input into a GUI design, does not retest existing user input responses of the GUI that are already known to function correctly.

Conventional test systems are used to evaluate recognition systems such as voice recognition systems or handwriting recognition systems. These conventional recognition systems employ a single set of rules for recognizing inputs. For example, a handwriting recognition system relies on a single set of rules for recognizing all of the characters in a handwriting sample. Accordingly, a conventional test system which evaluates the handwriting recognition system only has to determine how well the handwriting recognition system adheres to the expected rule set. The conventional test system does not test multiple rule sets within the handwriting recognition system to determine how well the rule sets work together to recognize characters.

### SUMMARY

Various embodiments of a system and methods for evaluating the usability and interoperability of touch gestures are described. The system for evaluating touch gestures, as described herein, may provide a mechanism for evaluating the interoperability of multiple touch gesture recognizers supported by a software application. As referred to herein, the interoperability of multiple touch gesture recognizers may be the collective ability of the touch gesture recognizers to correctly respond to touch gestures. A touch gesture may be applied to a touch-sensitive surface of a touch-enabled electronic device. A touch gesture recognizer may be configured to recognize and respond to the touch gesture. The operating system and/or software applications running on the electronic device may support multiple, different touch gestures. Each one of the multiple touch gesture recognizers may be configured to recognize and respond to a different one of the multiple touch gestures.

Each one of the multiple touch gesture recognizers may be designed to operate independently to recognize and respond to a particular touch gesture. A touch gesture recognizer may be tested independently to evaluate the ability of the touch gesture recognizer to correctly recognize and respond to the particular touch gesture. During an independent test of a touch gesture recognizer, touch gesture event data (e.g., from a touch gesture executed by a user on a touch-enabled surface) may be sent to the touch gesture recognizer. A gesture test system may determine how well the touch gesture recognizer responds to the touch gesture event data. The touch gesture event data may be recorded and stored as test data sets. The test data may include the touch gesture event data that represents an execution of the particular touch gesture.

The stored test data from independent tests of touch gesture recognizers may be used to evaluate the interoperability of the touch gesture recognizers. The stored test data may be sent, as an input test stream to the multiple touch gesture recognizers. The gesture test system may monitor the touch gesture recognizers to determine which touch gesture recognizers respond to the test data. The gesture test system may record the monitored results. Dependent on the monitored results, the gesture test system may determine whether interoperability issues exist for the multiple touch gesture recognizers.

### BRIEF DESCRIPTION OF THE DRAWINGS

FIG. 1 illustrates an example of a gesture test system which may be configured to evaluate the usability and interoperability of touch gestures, according to some embodiments.

FIG. 2 illustrates an example of a method that may be used to independently evaluate a touch gesture recognizer, according to some embodiments.

FIG. 3 illustrates an example of a gesture test system which may be configured to evaluate the interoperability of touch gesture recognizers, according to some embodiments.

FIG. 4 illustrates an example of a method that may be used to evaluate the interoperability of multiple touch gesture recognizers, according to some embodiments.

FIG. 5 illustrates an example of a method that may be used to tune the sensitivity of one or more touch gesture recognizers, according to some embodiments.

FIG. 6 illustrates an example of a method that may be used to determine a usability rating for a touch gesture, according to some embodiments.

FIG. 7 illustrates an example computer system that may be used in embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Various embodiments of a system and methods for evaluating the usability and interoperability of touch gestures are described herein. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

### Introduction

Various embodiments of a system and methods for evaluating the usability and interoperability of touch gestures are described herein. The system for evaluating touch gestures may provide a mechanism for evaluating and improving touch gesture recognition within a computing system. The system for evaluating touch gestures may perform a geometric analysis of a touch gesture to determine a degree of usability for the touch gesture. The system for evaluating touch gestures may evaluate touch gesture recognizers, both individually, and with multiple other touch gesture recognizers operating within a computing system. The evaluations may include real-time user testing and simulated user testing. The simulated user testing may use stored test data sets recorded during real-time user testing and may provide an efficient means for tuning the operation of touch gesture recognizers and for evaluating 3^{rd} party touch gesture recognizers.

The ability of a computing system to correctly interpret touch gestures may be dependent on both the proper execution of the touch gestures by users. A touch gesture may be evaluated for usability to determine how difficult, or easy, the gesture may be to execute, for example on, or proximate to, the surface of a touch-enabled device. The geometry of the touch gesture and the similarity of the touch gesture to other touch gestures may be evaluated. The touch gesture may also be evaluated, via real-time user tests, to determine users' success rate at executing the touch gesture.

The ability of a computing system to correctly interpret touch gestures may also be dependent on the computing system's recognition of the touch gestures. A computing system may include multiple gesture recognizers which may each be configured to recognize and respond to a particular gesture when the gesture is applied to a touch-enabled device of the computing system. A computing system's interpretation of a touch gesture may depend on the correct recognizer recognizing and responding to the touch gesture. Recognition of the touch gesture by a wrong touch gesture recognizer may result in misinterpretation of the touch gesture. Touch gesture recognizers may be individually evaluated to determine the touch gesture recognizers' ability to correctly recognize and respond to particular touch gestures. The interoperability of touch gesture recognizers may also be evaluated to determine the ability of the touch gesture recognizers to function collectively to correctly recognize and respond to touch gestures. Such interoperability testing may include sending an input test data stream of touch gesture event data sets to the multiple touch gesture recognizers and recording whether a correct touch gesture recognizer responds to each data set. The data sets may be stored data that may be recorded during real-time user testing of individual touch gestures and individual touch gesture recognizers.

The system for evaluating touch gestures may provide a mechanism for evaluating the interoperability of touch gesture recognizers that have been independently developed. For example, a software application may use touch gesture recognizers that are native to an operating system, touch gesture recognizers that have been developed by remotely located development teams, and 3^{rd} party touch gesture recognizers. The system for evaluating touch gestures may enable a developer of the software application to determine the interoperability of the touch gesture recognizers within the software application. The touch gesture recognizers may be compiled versions which do not have accessible source code, i.e., “black box” touch gesture recognizers. The system for evaluating touch gestures may enable a software application developer to determine whether independently developed touch gesture recognizers from different sources are likely to have conflicts which may result in misinterpretation of the gestures.

In other embodiments, the system described herein may not be limited to touch gestures. The system may provide a method for evaluating gestures other than touch gestures applied to the surface of a touch-enabled device. The system may be used with any input device that is configured to sense non-touch gestural motions at multiple locations. For example, the system may be used with an input device that is configured to sense non-touch gestural motions in multi-dimensional space. An example of such an input device may be a device that is configured to sense non-touch gestures that are performed while hovering over a surface, rather than directly contacting the surface. Other examples of non-touch gestural input devices that may be supported by the gesture test system are accelerometer-based motion input devices and input devices that sense motion within a magnetic field. Other input device technologies for recognizing non-touch gestural motions may also be supported. The input devices may also receive input via physical buttons and/or touch-sensitive surfaces. As yet another example, the system may be used with any type of computing input device which may indicate a gesture, such as a stylus input applied to a tablet PC. The gesture test system may support any combination of touch-sensitive and/or non-touch gestural input devices that may be operating concurrently to sense gestural input.

### Gesture Test System

The system for evaluating the usability and interoperability of touch gestures may be implemented as a touch gesture test system. Embodiments of a touch gesture test system, which may be implemented as or in a tool, module, plug-in, stand-alone application, etc., may be used to evaluate touch gestures applied to a touch-enabled device. For simplicity, implementations of embodiments of the system for evaluating the usability and interoperability of touch gestures described herein will be referred to collectively as a gesture test system.

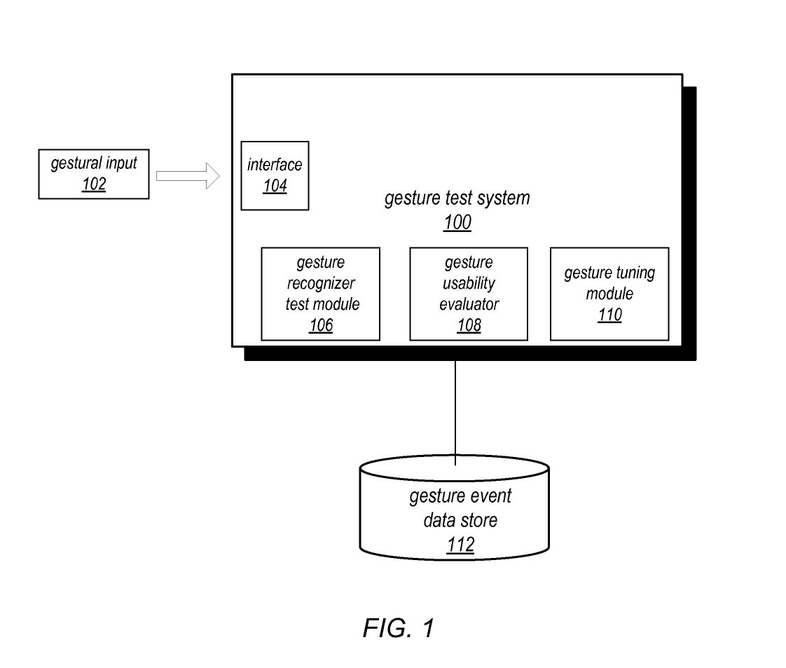

FIG. 1 illustrates an example of a gesture test system (element 100 of FIG. 1) which may be configured to evaluate the usability and interoperability of touch gestures, according to some embodiments. As illustrated in FIG. 1, gesture test system 100 may receive gestural input set 102 via interface 104. The input received via interface 104 may be touch event data that represent touch gestures that are included in gestural input set 102. For example, a user may execute the touch gestures, i.e. the gestural input, on a touch-enabled device. Touch event data which represents the touch gesture may be captured by a device driver of the touch-enabled device and sent to gesture test system 100. Gesture test system 100 may receive the touch event data, via interface 104, from the device driver.

Gesture recognizer test module 106 may independently evaluate a touch gesture recognizer to determine how accurately the touch gesture recognizer interprets touch event data that represents a particular touch gesture which corresponds to the touch gesture recognizer. Gesture usability evaluator 108 may calculate a usability rating for a touch gesture. The usability rating may be calculated by gesture usability evaluator 108 dependent on the results of a geometric evaluation of a touch gesture, a comparison of the touch gestures to other touch gestures and user execution of the touch gesture. Gesture tuning module 110 may be configured to automatically adjust the sensitivity of a touch gesture recognizer or provide feedback regarding suggested adjustments for the sensitivity of a touch gesture recognizer. Gesture event data store 112 may be used to store low-level gesture events (e.g., raw touch events) which represent touch gestures. The gesture event data stored in data store 112, as described below, may be used to test the individual functionality and interoperability of touch gesture recognizers.

### Independent Touch Gesture Recognizer Evaluation

A touch gesture recognizer may be configured to recognize and respond to a touch gesture applied to the touch-enabled surface of an electronic device. A software application may support multiple different touch gestures. Each one of the touch gestures supported by the software application may have a corresponding gesture recognizer implemented within the software application and/or an operating system in which the software application is executing. A touch gesture recognizer may be configured to recognize a particular touch gesture and interpret a command specified by the particular touch gesture. A touch gesture may be a continuous gesture which indicates a command that may continue to be executed throughout the duration of the gesture execution An example of a continuous touch gesture is a “zoom” gesture, which may be two digits moving towards or apart from one another on the surface of a touch-enabled device. The zoom gesture may continuously specify a command to zoom in or zoom out on a digital image displayed on a electronic device. One of the touch gesture recognizers, for example, a “zoom” gesture recognizer (i.e., a gesture recognizer which corresponds to a zoom gesture) may be configured to recognize and interpret the zoom command. A gesture recognizer for a continuous gesture may also be configured to provide real-time feedback as the gesture is applied. For example, the “zoom” gesture recognizer may provide real-time feedback which indicates the amount of zoom applied as a user is executing the gesture. A touch gesture may also be a “one-shot” gesture which indicates a single execution of a command indicated by the gesture. An example of a “one-shot” gesture may be “flick” gesture which indicates a command to undo a previous step.

Multiple gesture recognizers may receive a stream of touch event data (e.g., from a device driver of the touch-enabled surface) which represents the zoom gesture. The stream of touch event data may be a set of individual touch events. Each touch event may have a unique identifier and may include a set of (x,y) coordinates that indicate a position of the touch event on the surface of the touch-enabled device. Each of the gesture recognizers may evaluate the stream of touch event data to determine whether the touch event data indicates a particular touch gesture. The zoom gesture recognizer may recognize the particular touch event data as a zoom gesture and may respond to the gesture. For example, the zoom gesture recognizer may indicate to a software application that a zoom command has been received and may provide, to the software application, additional information regarding the zoom command. Such information may include, for example, the type of zoom specified by the command and an amount of zoom specified by the command.

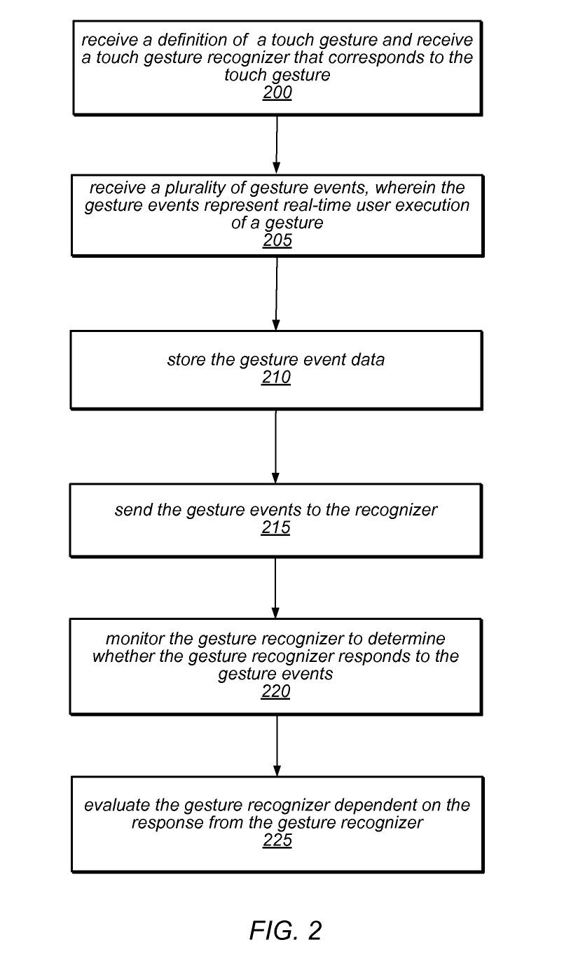

A touch gesture recognizer may be created as part of a gesture development process in which a new touch gesture is designed. The touch gesture recognizer may be self-contained and may be configured to operate independently to recognize a particular touch gesture. The touch gesture recognizer may implement a unique, independent rule set that corresponds to the particular touch gesture. The rule set may include rules for recognizing and interpreting the touch event data that represents the particular touch gesture. A touch gesture recognizer may be independently evaluated to determine how accurately the gesture recognizer interprets the touch event data that represents the particular touch gesture. Gesture test system 100 may be configured to test the independent functionality of a touch gesture recognizer. FIG. 2 illustrates a method that may be used by gesture test system 100 to independently evaluate a touch gesture recognizer, according to some embodiments. The method illustrated in FIG. 2 may be executed, for example, by gesture recognizer test module 106 of gesture test system 100.

As indicated at 200, the method illustrated in FIG. 2 may include receiving a definition of a touch gesture and receiving a touch gesture recognizer that corresponds to the touch gesture. The definition of the touch gesture may specify the geometry (i.e., shape) of the gesture and may provide instructions which indicate how the gesture is to be executed. The touch gesture definition may be of various different formats. As an example, the touch gesture definition may be expressed in a gesture definition language. A gesture definition language, as described in further detail below, may use various elements (such as icons or symbols) to represent the physical characteristics of a touch gesture. As another example, the definition of the touch gesture may be a graphical representation of the gesture, such as an image of the touch gesture. As yet another example, the definition of the touch gesture may simply be a textual description of the touch gesture which describes in words how the touch gesture is to be executed.

A touch gesture recognizer which is configured to recognize and interpret the corresponding touch gesture may also be received. The touch gesture recognizer may be software program code which expresses the rule set used by the touch gesture recognizer to recognize and interpret the touch event data which represents the touch gesture. The touch gesture recognizer may also be a compiled version of the software program code for the touch gesture recognizer. Such a compiled version of the touch gesture recognizer may be referred to herein as a “black box gesture recognizer,” as the rule set implemented within the touch gesture recognizer may not be visible.

As indicated at 205, the method illustrated in FIG. 2 may include receiving a plurality of gesture events, wherein the gesture events represent real-time user execution of a gesture. A set of gesture events may be touch event data that represents a user execution of the touch gesture. As described in further detail below, touch event data, or gesture event data, may be a set of (x,y) coordinates which may indicate locations on the surface of a touch-enabled device that are contacted by a touch gesture. Each set of coordinates may be associated with a unique identifier.

The gesture events may be generated via real-time user execution of the touch gesture during user testing of the gesture recognizer. User testing may be performed by directing one or more users to execute multiple iterations of the touch gesture. The one or more users may be provided instructions for executing the touch gesture. The instructions may be dependent on the touch gesture definition. Each user may execute the touch gesture multiple times, for example, by applying the touch gesture to a touch-enabled surface. The user testing may be executed on gesture test system 100, for example, via a touch-enabled device implemented in, or coupled to, gesture test system 100. During execution of the user testing, gesture test system 100 may be coupled to the touch gesture recognizer which is under test. Gesture recognizer test module 106 of gesture test system 100 may receive the gesture events which represent repeated user execution of the touch gesture. The gesture events (i.e., gestural input 102) may be received via interface 104 of gesture test system 100. The gesture events may also be previously stored touch event data, generated during prior user testing of the touch gesture recognizer.

As indicated at 210, the method illustrated in FIG. 2 may include storing the gesture event data. Gesture event data may be the low-level touch event data that represents the execution of the touch gesture. For each user execution of the touch gesture, test module 106 may record and store the gesture event data that represents the execution of the touch gesture. Test module 106 may store the gesture event data in gesture event data store 112. As an example, test module 106 may create a software vector structure which represents a touch gesture. Each element of the software vector structure may contain a coordinate pair which indicates a location of each touch gesture event. The gesture events may be stored for future gesture recognizers test. The stored gesture event data may be used to simulate real-time user inputs during the gesture recognizer tests.

As indicated at 215 of FIG. 2, gesture recognizer test module 106 may send the gesture events to the touch gesture recognizer that is under test. As described above, the touch gesture recognizer may be coupled to gesture test system 100. As indicated at 220, the method illustrated in FIG. 2 may include monitoring the gesture recognizer to determine whether the gesture recognizer responds to the gesture events. For example, test module 106 may monitor the gesture recognizer. As described above, a touch gesture recognizer may be configured to recognize and respond to a particular touch gesture. The touch gesture recognizer that is under test may analyze the received gesture events to determine whether the gesture events specify the particular touch gesture. If the gesture events specify the particular touch gesture, the touch gesture recognizer may recognize and respond to the touch event data set. The touch gesture recognizer may provide an indicator that the particular touch gesture has been received. The indicator may specify whether the touch gesture recognizer has recognized the touch gesture. As an example, the touch gesture recognizer may provide a positive response for a recognized gesture and may provide a negative response for an unrecognized gesture. Test module 106 may track the number of touch gestures for which the touch gesture recognizer provides a positive response.

As indicated at 225, the method illustrated in FIG. 2 may include evaluating the gesture recognizer dependent on the response from the gesture recognizer. For example, test module 106 may perform a statistical analysis, dependent on the stored gesture events and the stored number of touch gesture recognizer responses, to evaluate the performance of the touch gesture recognizer. For gesture events generated via real-time user execution of the touch gesture, test module 106 may determine which ones of the stored gesture executions represent correct executions of the touch gesture.

Test module 106 may request user input to determine which ones of the stored gesture executions represent correct executions of the touch gesture. Test module 106 may reproduce each touch gesture, as executed by a user, from the gesture event data that corresponds to the user execution of the touch gesture. As an example, test module 106 may reproduce each user execution of a touch gesture and may output a graphical representation of each user execution of the touch gesture. Test module 106 may present the graphical representations of the touch gestures to a user for analysis.

A user may analyze each graphical representation of the touch gesture to determine how well the touch gesture was executed. More specifically, the graphical representations of the touch gesture may be analyzed to determine whether the touch gesture was executed accurately enough to be recognized by the gesture recognizer. Dependent on the analysis of the graphical representations of the touch gesture, the user may determine a number of gesture executions that were accurate enough to be recognized by the recognizer. As an example, 100 iterations of the touch gesture may have been executed during the test process. The user may determine that 60 of the gesture executions were accurate enough to be recognized by the gesture recognizer. The user may input the number of accurate gesture executions into the gesture test system, for example, via a user interface of the gesture test system.

Test module 106 may use various methods to evaluate the performance of the touch gesture recognizer dependent on the number of accurate gesture executions and the number of positive responses. In some embodiments, test module 106 may determine that the performance of a touch gesture recognizer is acceptable if the difference between the number of accurate gesture executions and the number of positive responses is below a certain threshold. The threshold may be expressed as a percentage of the total number of gesture executions. Note that a touch gesture recognizer may also provide a positive response for gesture executions that are not accurate enough. In such cases, the touch gesture recognizer may have too high a tolerance in evaluating touch event data. Accordingly, the absolute value of the difference between the number of accurate gesture executions and the number of positive responses may be compared to the threshold. The performance of a touch gesture recognizer may be considered acceptable if the equation (1) is satisfied.

|(accurate gestures−positive responses)|<T (1)

where T represents the threshold and is calculated as a percentage of the number of gesture executions.

Continuing with the example described above, 100 real-time gesture executions may have been stored. A user may have analyzed graphical representations of the 100 real-time gesture executions to determine that 60 of the gesture executions were accurate enough to be recognized by the touch gesture recognizer. Test module 106 may compare the number of accurate gesture executions to the number of positive responses from the touch gesture recognizer. As an example, test module 106 may have received 55 positive responses from the touch gesture recognizer. The threshold for acceptable performance of the touch gesture recognizer may be 10% of the gesture executions, which, for example, may be 10 (e.g., 10% of 100 gesture executions). In such as example, the performance of the touch gesture recognizer may be considered acceptable, as the absolute value of the difference between the number of accurate gesture executions and the number of positive responses is 5, which is within the threshold value of 10.

As described above, the gesture event data (i.e., low-level touch events) may be stored. The stored gesture event data may be used for further testing of individual touch gesture recognizers, or, as described below, for interoperability tests of touch gesture recognizers. The result of a user analysis of a gesture execution (i.e., the determination of whether the execution accurately represents the gesture) may be stored with the touch event data set for the gesture execution. Accordingly, a stored gesture execution may include an accuracy indicator which specifies whether the gesture events represent an accurate execution of a touch gesture. The accuracy indicator for each stored gesture execution may be used for future touch gesture recognizer tests. For example, a number of accurate gesture executions input to a touch gesture recognizer may be determined by analyzing the accuracy indicators of the stored gesture executions, rather than requiring user analysis.

### Touch Gesture Recognizer Interoperability Evaluation

Gesture test system 100 may evaluate the interoperability of multiple touch gesture recognizers that may be implemented within a computing system. The interoperability of multiple gesture recognizers may be a measure of how well the multiple gesture recognizers work together to correctly recognize and respond to touch gestures applied to a touch-enabled device of the computing system. For example, the interoperability of a touch gesture recognizer may indicate the ability of the gesture recognizer to correctly recognize and respond to a particular corresponding touch gesture and not misinterpret touch gestures which correspond to other gesture recognizers within the computing system.

A computing system's interpretation of a touch gesture may be dependent on which gesture recognizers recognize and respond to the gesture when the gesture is applied to the touch-enabled device. For example, a user may apply a zoom gesture to the touch-enabled device. If the gesture recognizer which corresponds to the zoom gesture recognizes and responds to the zoom gesture, the zoom gesture may be correctly interpreted by the computing system as a zoom gesture. However, if a gesture recognizer that does not correspond to the zoom gesture also recognizes and responds to the zoom gesture, the zoom gesture may be misinterpreted by the system. For example, if the zoom gesture is recognized by a gesture recognizer that corresponds to a rotate gesture, the zoom gesture may be misinterpreted by the system as a rotate command. To support correct interpretations of touch gestures within a computing system, the multiple touch gesture recognizers may be tested together to determine whether interoperability issues exist for the touch gesture recognizers.

As described above, a software application may use touch gesture recognizers that are native to an operating system, touch gesture recognizers that have been developed by remotely located development teams, and 3^{rd} party touch gesture recognizers. The system for evaluating touch gestures may enable a developer of the software application to determine the interoperability of the touch gesture recognizers used by the software application. Each of the touch gesture recognizers may have been independently designed (e.g., by a 3^{rd} party software developer) to recognize and respond to a particular touch gesture. The gesture test system may test the multiple touch gesture recognizers to determine how well the recognizers work together to correctly recognize and respond to touch gestures. As an example, a software application may support pan, zoom and rotate touch gestures. The gesture test system may provide the pan, zoom and rotate gestures as test input to the corresponding pan, zoom and rotate gesture recognizers. The gesture test system may determine whether each gesture recognizer responds to a corresponding gesture as expected. For example, the gesture test system may determine whether the zoom gesture recognizer responds only the zoom command and does not respond to the pan or rotate commands.

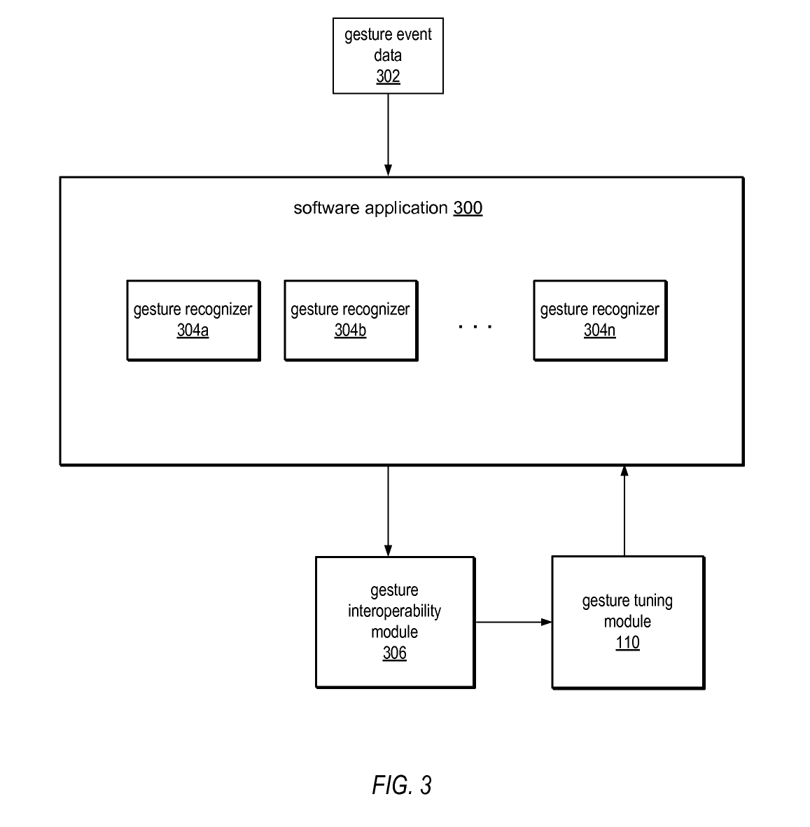

FIG. 3 illustrates an example of a gesture test system which may be configured to evaluate the interoperability of touch gesture recognizers, according to some embodiments. Multiple touch gesture recognizers 304a through 304n may be used by software application 300 to recognize and respond to touch gestures represented by gesture event data 302. Gesture interoperability module 306 may be configured to receive responses to gesture event data 302 from gesture recognizers 304a through 304n. Gesture interoperability module 306 may be configured to determine whether interoperability issues exist for gesture recognizers 304a through 304n. Gesture tuning module 110, as in FIG. 1, may tune the sensitivities of gesture recognizers 304a through 304n to resolve the interoperability issues.

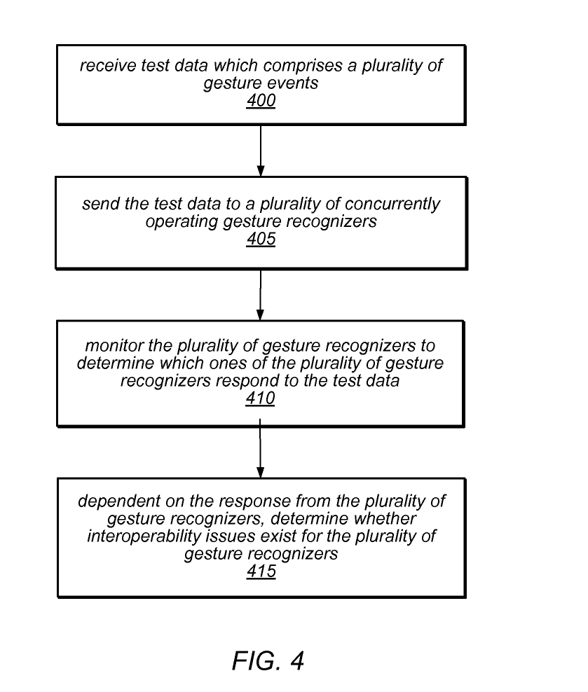

FIG. 4 illustrates a method that may be employed by gesture test system 100 to evaluate the interoperability of multiple touch gesture recognizers, according to some embodiments. Gesture interoperability module 306 may be configured to execute the method illustrated in FIG. 4. The method illustrated in FIG. 4 for testing the interoperability of multiple touch gesture recognizers may be executed in a similar manner as the method illustrated in FIG. 2 for independently evaluating a touch gesture recognizer.

As indicated at 400, the method illustrated in FIG. 4 may include receiving test data which comprises a plurality of gesture events. For example, the test data may be touch gesture event data recorded during independent touch gesture recognizer tests, as describe above in regard to FIG. 2. The test data may also be touch gesture event data recorded during a usability evaluation of an individual touch gesture, as described in further detail below. Accordingly, the gesture recognizer interoperability test may re-use gesture event data recorded in prior tests. The prior tests, such as the independent gesture recognizer tests, may involve real-time gestures executions by users. The re-use of gesture event data may enable the gesture test system to simulate real-time user input for the interoperability test. The test data may be stored in gesture event data store 112.

As an example, interoperability module 306 may receive test data which represents touch gestures A and B that are natively supported within an operating system. Interoperability module 306 may also receive test data which represents touch gestures C and D that were developed by an internal software development team. Interoperability module 306 may also receive test data which represents touch gestures E and F that were developed by a 3^{rd} party software development team.

As indicated at 405, the method illustrated in FIG. 4 may include sending the test data to a plurality of concurrently operating touch gesture recognizers. The plurality of touch gesture recognizers may be concurrently operating to receive touch gesture events and interpret the touch gesture events as commands for a software application. As an example, gesture recognizers 304a through 304n may correspond to (i.e., may be configured to recognize and respond to) the touch gestures A through F. The gesture test system may send test data representing each of the touch gestures A through F to gesture recognizers 304a through 304n.

As indicated at 410, the method illustrated in FIG. 4 may include monitoring the plurality of gesture recognizers to determine which ones of the plurality of gesture recognizers respond to the test data. As described above, each touch gesture recognizer may evaluate received test data to determine whether the test data set specifies a particular touch gesture which corresponds to the touch gesture recognizer. As an example, touch gesture recognizer A may evaluate the test data to determine whether the test data specifies touch gesture A. If the test data specifies the particular touch gesture, the touch gesture recognizer may respond to the test data. The touch gesture recognizer may send an indicator that the particular touch gesture has been received. For example, upon recognizing a test data that is equivalent to touch gesture A, touch gesture recognizer A may send an indicator to the software application that touch gesture A has been received. In some embodiments, each touch gesture recognizer may send an indicator in response to each test data set. The indicator may specify whether the touch gesture recognizer has recognized the test data. As an example, the indicator sent by the touch gesture recognizer may include a positive response for a recognized gesture and may include a negative response for an unrecognized gesture. For example, touch gesture recognizer A may provide a positive response to test data that represents touch gesture A. Touch gesture recognizer may provide a negative response to test data that represent other touch gestures, such as gestures B through F.

Gesture interoperability module 306 may record data which indicates the touch gesture recognizers that respond to the test data. As an example, the test data may be partitioned such that each partition of test data represents a particular touch gesture. For each partition of test data, or each touch gesture, gesture interoperability module 306 may record the gesture recognizers that respond to the touch gesture. As an example, gesture interoperability module 306 may determine that gesture recognizers A and B responded to touch gesture A. Gesture interoperability module 306 may record data that indicates that gesture recognizers A and B responded to touch gesture A. Alternatively, gesture interoperability module 306 may record data that indicates that two gesture recognizers responded to touch gesture A.

The gesture test system may also be used to evaluate simultaneous interoperability for a group of touch gesture recognizers. More specifically, the gesture test system may determine whether the group of gesture recognizers is capable of correctly recognizing and responding to multiple, simultaneously executed touch gestures. As an example, a touch-sensitive display may support multiple users simultaneously executing touch gestures. The gesture test system may send, to the group of touch gesture recognizers, in a process similar to that described above, test input which represents multiple, simultaneous executions of touch gestures. The gesture test system may determine which touch gesture recognizers respond to the simultaneous touch gestures.

As indicated at 415, the method illustrated in FIG. 4 may include, dependent on the response from the plurality of gesture recognizers, determining whether interoperability issues exist for the plurality of gesture recognizers. Interoperability module 306 may determine that at least one interoperability issue exists for a plurality of gesture recognizers if more than one gesture recognizer responds to any of the touch gestures represented by the test data. Interoperability module 306 may issue a report detailing the determined interoperability issues. As an example, interoperability module 306 may indicate touch gestures for which interoperability issues exist. Following the example described above, interoperability module 306 may indicate than an interoperability issue exists for touch gesture A because more than one gesture recognizer responded to touch gesture A. The report may detail which gesture recognizers responded to each gesture for which an interoperability issue exists. For example, the report may indicate that gesture recognizers A and B responded to touch gesture A.

In other embodiments, interoperability module 306 may determine, dependent on the recorded results, a number of “false positive” responses that were issued by each touch gesture recognizer. A “false positive” response may indicate that a touch gesture recognizer has responded to an incorrect touch gesture, i.e., a touch gesture that does not correspond to the touch gesture recognizer. For example, a positive response of touch gesture recognizer A to touch gesture C may be considered a “false positive” response. Dependent on the number of “false positive” responses issued by a touch gesture recognizer, interoperability module 306 may calculate an interoperability level for the touch gesture recognizer. The interoperability level may, for example, be expressed as a percentage and may be calculated dependent on the total number of test data sets. As an example, the interoperability, I, of a touch gesture recognizer may be expressed as indicated in Equation (2):

I=100*[1−(# of false positive responses/# of data sets)] (2)

Substituting in equation (2), a touch gesture recognizer which issues 5 false positive responses out of 100 data test sets may have an interoperability level of 95%. In other embodiments, test module 106 may calculate the interoperability level of a touch gesture recognizer using various methods. As an example, the interoperability level calculation may also be dependent on the number of accurate responses issued by the touch gesture recognizer.

The interoperability level calculated by interoperability module 306 may enable a software application developer to determine whether a particular touch gesture recognizer is compatible with a group of other touch gesture recognizers supported within a software application. For example, touch gesture recognizer F, as described above, may be configured to respond to touch gesture F. However, when tested with touch gestures A through E, touch gesture recognizer F may repeatedly respond to touch gesture E. Accordingly, interoperability module 306 may determine that touch gesture recognizer F has a low interoperability level when combined with touch gesture recognizers A through E. Based on the low interoperability level for touch gesture recognizer F, the software application developer may decide to use a different touch gesture recognizer F from a different development source. The stored test data sets may enable the developer to efficiently repeat the interoperability test for the different touch gesture recognizer F. In other embodiments, the software developer may update touch gesture recognizer F to improve the interoperability level of touch gesture recognizer F. Similarly, the stored test data sets may enable the developer to efficiently repeat the interoperability test for the updated touch gesture recognizer F.

### Touch Gesture Recognizer Tuning

The gesture test system may provide a mechanism for automatically tuning, or adjusting, the sensitivity of a touch gesture recognizer. The sensitivity of a touch gesture recognizer may be a measure of the touch gesture recognizer's tolerance in recognizing a touch gesture. For example, the sensitivity of a touch gesture recognizer may be increased such that the gesture recognizer expects a less precise execution of a touch gesture. In other words, the touch gesture recognizer becomes “more sensitive” to a corresponding touch gesture. As another example, the sensitivity of a touch gesture may be decreased such that the gesture recognizer expects a more precise execution of a touch gesture. In other words, the touch gesture recognizer becomes “less sensitive” to a corresponding touch gesture.

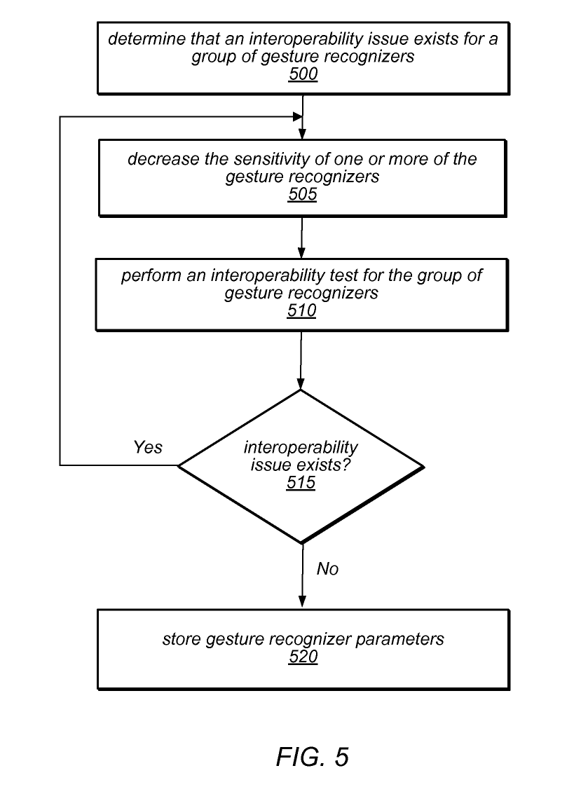

FIG. 5 illustrates a method that may be used by gesture test system 100 to automatically tune the sensitivity of one or more touch gesture recognizers, according to some embodiments. Gesture tuning module 110 may perform the method illustrated in FIG. 5 to tune the sensitivity of one or more touch gesture recognizers. As indicated at 500, the method illustrated in FIG. 5 may include determining that an interoperability issue exists for a group of gesture recognizers. For example, an output of element 415 of FIG. 4 may be a determination that an interoperability issue exists for a group of gesture recognizers. An interoperability issue may indicate that overlap exists between the sensitivities of multiple gesture recognizers. For example, the sensitivity levels of two different gesture recognizers may be set such that both of the gesture recognizers respond to a particular gesture. In such a case, the sensitivity levels may be adjusted to remove the interoperability issue.

As indicated at 505, the method illustrated in FIG. 5 may include decreasing the sensitivity of one or more of the gesture recognizers. A touch gesture recognizer may include various tolerance parameters that determine the sensitivity of the gesture recognizer. An example of a tolerance parameter of a touch gesture may be a required range of spatial distance between two digits of a two digit touch gesture. The tolerance parameters may be adjusted to change the sensitivity level of the touch gesture recognizer. For example, the range of spatial distance expected by the touch gesture recognizer may be increased. In such an example, the range of spatial distance adjustment may decrease the sensitivity of the touch gesture recognizer to a corresponding touch gesture. Accordingly, the gesture recognizer may expect a more precise execution of the touch gesture before responding to the touch gesture. At 505, the sensitivity levels for gesture recognizers for which interoperability issues exist may be decreased such that the amount of overlap between the sensitivities of the gesture recognizers is reduced or eliminated.

As indicated at 510, the method illustrated in FIG. 5 may include performing an interoperability test for the group of gesture recognizers. The interoperability test may be performed in a manner similar to that described in FIG. 4. The interoperability test may indicate any interoperability issues that exist for the group of gesture recognizers. At decision point 515 of FIG. 5, tuning module 110 may determine whether interoperability issues still exist for the group of gesture recognizers. If interoperability issues exist, shown as the positive exit of 515, the method may return to 505. The sensitivity of one or more of the touch gesture recognizers may be further decreased at block 505. Blocks 505 through 515 of FIG. 5 may be repeated until no interoperability issues exists for the group of gesture recognizers, shown as the negative exit of block 515.

As indicated at block 520, the gesture recognizer parameters may be stored. Based on the stored gesture recognizer parameters, tuning module may issue a report detailing the gesture recognizer parameters that are necessary to remove interoperability issues. In an alternative embodiment, tuning module 110 may store the recognizer parameters after each iteration of block 515. Based on the iterations of stored data, tuning module 100 may issue a report which describes various gesture recognizer parameters which may result in various levels of interoperability. Such a report may enable a software application developer to determine that some level of interoperability is acceptable within a software application. For example, based on the report, the developer may determine two gesture recognizers may have a conflict in responding to gestures. The developer may determine that the gesture recognizers correspond to two very similar gestures, for example, fine grain rotate and coarse grain rotate. Since the gesture recognizers correspond to such similar gestures, the developer may decide that some level of gesture recognition conflict between the two gesture recognizers is acceptable.

Using a method similar that illustrated in FIG. 5, touch gesture recognizer sensitivities may also be adjusted to enable a maximum amount of efficiency in user execution of touch gestures. The touch gesture recognizers within a software application that supports multiple similar two digit touch gestures such as pan, zoom and rotate may be tuned such that the similar touch gestures are not misinterpreted by the software application. In such an example, the sensitivities of the touch gesture recognizers to their corresponding touch gestures may be decreased such that there is no overlap between the expected executions of the similar gestures. Accordingly, precise user execution of the pan, zoom and rotate touch gestures may be required for the corresponding touch gesture recognizers to recognize and respond to the touch gestures.

As another example, a software application may only support a pan touch gesture and may not support zoom and rotate gestures. In such an example, the software application may not be concerned with the misinterpretation of similar pan, zoom and rotate commands since only the pan command may be supported. Accordingly, the sensitivity of the pan touch gesture recognizer may be decreased such that a less precise user execution of the pan gesture is required for recognition of the pan touch gesture. A user may be able to more quickly, or efficiently, execute the pan gesture since a less precise gesture may be required.

The gesture test system may be configured to adjust the sensitivities of touch gesture recognizers such that a minimum amount of precision is required in user executions of the touch gestures. As shown in the examples described above, the sensitivity level for each touch gesture may be dependent on similar touch gestures supported by a software application. Accordingly, the gesture test system may execute gesture tuning, as described above and illustrated in FIG. 5, to determine appropriate sensitivity levels for each touch gesture recognizer supported by a software application. In other embodiments, tuning module 110 may also use a method similar to the method illustrated in FIG. 5 to tune the sensitivity of a gesture recognizer according to the expected manual dexterity or motor skills of a user.

### Gesture Usability Evaluation

A touch gesture may be evaluated to determine a level of usability for the gesture. As described herein, a level of usability for a touch gesture may represent an expected success rate for a user attempting to correctly execute the gesture. In other words, a level of usability for a touch gesture may indicate how difficult, or how easy, the gesture is to physically execute. For simplicity, a level of usability for a touch gesture may be referred to herein as a usability rating. The gesture test system may use a set of heuristics to determine a usability rating for a touch gesture. A usability rating for a touch gesture may be dependent on the geometry of the gesture (i.e., the shape of the gesture), a level of distinction (i.e., difference) between the gesture and other gestures, and the ability of users to learn the gesture and successfully repeat multiple iterations of the gesture. The system for evaluating touch gestures may calculate, for a touch gesture, a geometry rating based on the physical nature of the gesture, a similarity rating based on the distinctive nature of the gesture and a user rating based on user's ability to successfully learn and repeat the gesture. A usability rating for the touch gesture may be calculated based on any one of, or any combination of, the geometry rating, the similarity rating, and/or the user rating of the gesture.

A usability rating for a touch gesture may be dependent on the physical characteristics of the gesture. Some examples of the physical characteristics of a touch gesture may be a number of touch points, spacing between the touch points, and the path of the gesture. The physical characteristics of a touch gesture may determine how difficult, or easy, the gesture is to execute. For example, if the touch gesture requires a large number of touch points, touch points which are in very close proximity, and/or execution of a complex curvature pattern, the gesture may be difficult for a user to correctly execute. In such an example, the touch gesture may have a low usability rating.

The system for evaluating a touch gesture may analyze the physical characteristics of the gesture to calculate a geometry rating for the gesture. The system for evaluating a touch gesture may also compare the physical characteristics of the gesture to the physical characteristics of other gestures to calculate a similarity rating for the gesture. The system for evaluating a touch gesture may also record and analyze the results of multiple users executing repeated iterations of the gesture. Dependent on the ability of the multiple users to successfully execute the touch gesture, the system for evaluating a touch gesture may calculate a user rating for the gesture. Based on a statistical analysis of the results of the geometric evaluation, the comparison to other gestures and user execution of the gesture, the system may determine a usability rating for the touch gesture.

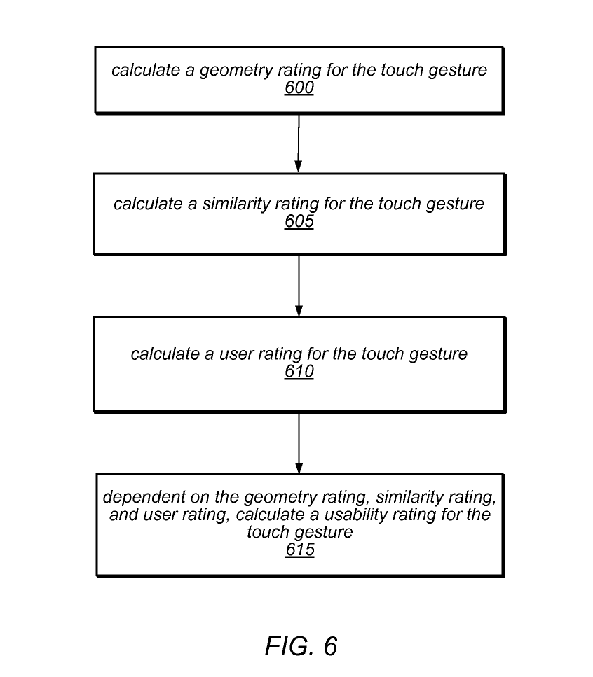

A usability rating for a touch gesture may be determined by gesture usability evaluator 108 of gesture test system 100. Usability evaluator 108 may be configured to perform a method such as illustrated in FIG. 6 to determine a usability rating for a touch gesture. As shown at 600, the method illustrated in FIG. 6 may include calculating a geometry rating for the touch gesture. Usability evaluator 108 may analyze the physical characteristics of a touch gesture to evaluate and rate the geometry of the gesture. The physical characteristics of a touch gesture may define the geometry, or shape of the gesture.

Examples of physical characteristics that may define the geometry of a touch gesture may include, but are not limited to: the number of touch points (i.e. number of contact points with the surface of a touch-enabled device), touch point locations (i.e., coordinate positions of the touch points), relative distance between touch points, trajectory of each touch point, amount of pressure applied at each touch point, speed of trajectories (i.e., speed of the touch gesture's motion), area of contact of each touch point, timeline (i.e., beginning, progression and end of the touch gesture), and scale (e.g. the radius of a circular touch gesture).

The types of touch gesture characteristics supported by touch-enabled devices may vary between different types of devices. For example, some touch-enabled devices may support a set of common touch gesture characteristics such as touch point locations, speed and direction. Other touch-enabled devices may support an extended set of touch gesture characteristics which may include, in addition to the common touch gesture characteristics, an extended set of characteristics such as number of digits used (multi-touch gestures), amount of pressure applied at touch points, and area of contact of each touch point. Accordingly, the gesture test system may evaluate touch gestures based on a set of common and/or extended gesture characteristics.

Usability evaluator 108 may receive data which represents the physical characteristics of a touch gesture (i.e., gesture input 102) via interface 104 of gesture test system 100. The data received by usability evaluator 108 as gesture input 102 may, in various embodiments, be different data types. As an example, gesture input 102 may be a definition of the touch gesture that is expressed in a gesture definition language. A gesture development tool, such as described in U.S. application Ser. No. 12/623,317 entitled “System and Method for Developing and Classifying Touch Gestures” filed Nov. 20, 2009, the content of which is incorporated herein in its entirety, may generate a definition of a touch gesture using a gesture definition language. For example, a gesture development tool may provide a mechanism for a gesture developer to represent a gesture using the gesture definition language.

A gesture definition language may define various elements which may represent the physical characteristics of a touch gesture. The gesture definition language may contain graphical elements that represent various touch gesture parameters. The gesture definition language may, for example, contain a set of icons, with each icon representing a gesture parameter or characteristics of a gesture parameter. For example, an icon depicting an upward-facing arrow may represent an upward trajectory for a touch gesture motion. The gesture definition language may also contain various other graphical representations of touch gesture parameters. For example, the gesture definition language may contain various curves and lines that a developer may combine to form a touch gesture. In a manner analogous to musical notation, the graphical elements of the gesture definition language may be various symbols (e.g., icons and/or other representations as described above) placed on a timeline. As with musical notes depicted in sheet music, the elements of the gesture definition language may be presented on the timeline in a manner that represents the relative timing of the multiple gesture parameters that form a complete gesture. For example, a symbol on a timeline may indicate that a particular parameter of a gesture (e.g., one finger down at a particular set of coordinates) occurs for a certain amount of time (e.g., one to two seconds). In such an example, the timeline of the gesture definition language may further indicate that a next gesture parameter (e.g., a horizontal swipe of the finger) may occur a certain amount of time (e.g., two to three seconds) after the preceding parameter.

Dependent on the physical characteristics of the touch gesture that are represented in the gesture definition language, the gesture development tool may create a gesture descriptor which represents the touch gesture. The gesture descriptor may be a unique representation of the touch gesture. The gesture descriptor may be formed by the gesture development tool as a software vector structure, where each element of the vector may be a set of values representing a particular physical characteristic of the touch gesture over time. The gesture development tool may create a software recognizable representation of each physical characteristic value and store each representation in a designated element of the vector. As an example, element 0 of a gesture descriptor vector may represent the “number of touch points” characteristic for the touch gesture. The gesture descriptor vector may be stored by the gesture development tool and made available for use by usability evaluator 108 of gesture test system 100.

As another example, the data received by usability evaluator 108 as gesture input 102 may be raw touch gesture data which represents touch events applied to the surface of a touch-enabled device. Gesture test system 100 may include a touch-enabled device which may be configured to receive a touch gesture via a user application of the touch gesture to a touch-enabled surface. In such an embodiment, a user may apply a touch gesture to the touch-enabled surface of gesture test system 100, or coupled to gesture test system 100, and may request, via an interface of gesture test system 100, a usability rating for the touch gesture. A device driver of the touch-enabled device, or the operating system running on the touch-enabled device, may capture the raw touch gesture data from the surface of the touch-enabled device. The touch gesture data (i.e., gestural input 102) may be sent, or made available, by the device driver to gesture test system 100. The touch gesture data may represent various physical characteristics of the touch gesture, dependent on the capabilities of the touch-enabled device.

The touch gesture data may include a plurality of touch events and each touch event may be represented by multiple spatial coordinates. For example, a stationary touch event may be represented by a set of proximate coordinates which represent the area covered by a stationary touch gesture. A mobile touch event may be represented by a set of coordinates which represent the gesture's motion across the surface of the touch-enabled device. Accordingly, a touch gesture data set may include a plurality of spatial coordinates. The device driver of a touch-enabled device, or an operating system for test system 100, may create a software recognizable representation of each spatial coordinate captured for the touch gesture. Each representation of a spatial coordinate may, for example, include a horizontal component (i.e., an “x” component) and a vertical component (i.e., a “y” component) which identify a location of the touch gesture on the surface of the touch-enabled device. As an example, the device driver, or operating system, may form a software vector structure which may contain the multiple coordinate pairs that represent the spatial coordinates of a touch gesture. Each element of the software vector may contain a pair of coordinate values, for example, an (x,y) pair of coordinate values. Each coordinate pair may also be associated with a unique identifier that distinguishes each touch event from other touch events of the gesture. Each individual touch event of a gesture may be represented in the software vector by a spatial coordinate pair and a unique identifier.

As described above usability evaluator 108 may receive, or access a stored version of, data which represents the physical characteristics of a touch gesture in the form of a gesture definition language expressed as a gesture descriptor, raw touch event data, or software program code. In other embodiments, other representations of the physical characteristics of a touch gesture are possible. For example, the physical characteristics of the touch gesture may be represented by software program code. Dependent on the data, usability evaluator 108 may determine various physical characteristics of the touch gesture. For example, usability evaluator 108 may determine physical characteristics of a touch gesture such as the number of touch points of the gesture, the spatial distance between each of the touch points of the gesture, and the number of changes in direction in the path of the gesture.

The number of touch points of a gesture may be represented by a value within a particular element of the gesture descriptor software vector. For example, as described above, element 0 of the gesture descriptor software vector may contain a value which indicates the number of touch points of a gesture. The number of touch points of a gesture, as another example, may be equivalent to the number of coordinate pairs present in the touch event data for a gesture. As described above, each touch point of a gesture may be represented by a coordinate pair in a set of touch event data for the gesture. Accordingly, the number of coordinate pairs in a set of touch event data for a gesture may be equivalent to the number of touch points of the gesture.

The spatial distance between the touch points of a touch gesture may be determined by calculating the distance between the coordinates of the touch points of the gesture. Note that touch gestures may be stationary or mobile and that multi-touch gestures may include any combination of mobile and/or stationary touch gestures. The spatial position of a stationary touch gesture may be represented by a set of coordinates which indicate the surface area of the touch that is applied. The trajectory of a mobile touch gesture may be represented by a set of coordinates which indicate the path of the mobile touch gesture across the surface. A calculation of the distance between touch points may first determine the appropriate coordinates to be used in a distance calculation. For example, the distance between two stationary touches may be calculated using the center coordinates of the two stationary touches. In an alternative embodiment, the distance between two stationary touches may be determined by calculating the distance between the pair of coordinates (i.e., one set of coordinates from each one of the stationary gestures) of the two touches that are in closest proximity.

Usability evaluator 108 may also use the coordinate data set for a mobile touch gesture, to evaluate the path of the mobile gesture. The coordinates for a mobile touch gesture may indicate the trajectory of the mobile gesture as the gesture is applied to a touch-enabled surface. Usability evaluator 108 may evaluate the set of coordinates to determine the number of changes in direction of the mobile touch gesture. The examples of physical characteristics of a touch gesture that may be determined by usability evaluator 108 as provided as examples and are not meant to be limiting. In alternate embodiments, other physical characteristics of a touch gesture may be determined in order to rate the geometry of the gesture.

A library of gesture rules may indicate a number of rules, or guidelines, that a touch gesture may follow such that the touch gesture may be successfully executed by typical users. The library of gesture rules may be based on prior user testing of touch gestures and may specify the desired physical characteristics of touch gestures. For example, the gesture rules may specify a maximum number of touch points for a touch gesture. As another example, the gesture rules may specify a minimum distance between touch points. As yet another example, the gesture rules may specify a maximum number of direction changes for a touch gesture. The examples of physical characteristics of a touch gesture that may be represented in a library of gesture rules are provided as examples and are not meant to be limiting. The gesture test system may include additional gesture rules.

Usability evaluator 108 may compare the determined physical characteristics of a touch gesture to the library of gesture rules. For example, the number of touch points of a gesture may be compared to the maximum number of touch points specified by the library of gesture rules. The distance between each of the touch points of a gesture may be compared to the minimum distance specified by the library of gesture rules. The number of direction changes of a touch gesture may be compared to the maximum number of changes specified by the library of gesture rules.

Dependent on the comparison of the touch gesture physical characteristics to the library of gesture rules, usability evaluator 108 may calculate a rating for the geometry of the touch gesture. The usability evaluator 108, in various embodiments, may use different methods to calculate the geometry rating for the touch gesture. As an example, usability evaluator 108 may use a binary value for the geometry rating. The geometry rating of the touch gesture may be one of two options. The options may be ratings such as “poor” or “good,” for example, or the options may be represented by numerical values, such as 0 and 1. In such an example, if any one of the physical characteristics of the touch gesture does not meet the guidelines of the gesture rules, usability evaluator 108 may assign a rating of “poor” (or an equivalent numerical value) to the geometry of the gesture. A rating of “good” (or an equivalent numerical value) may be assigned to the geometry of the gesture if all of the physical characteristics of the gesture meet the guidelines of the gesture rules. As another example, usability evaluator 108 may calculate the geometry rating of a touch gesture based on a percentage of the physical characteristics which meet the guidelines of the gesture rules. For instance, if 8 out of 10 physical characteristics of the gesture meet the guidelines of the gesture rules, the gesture may be given a geometry rating of 80%.

As indicated at 605, the method illustrated in FIG. 6 may include calculating a similarity rating for the touch gesture. The gesture test system may compare the gesture descriptor to an existing set of gesture descriptors. The comparison may be performed by usability evaluator 108 of the gesture development tool. The gesture development tool may perform the comparison to determine whether the touch gesture may be too similar to a previously defined touch gesture. Touch gestures that are very similar (i.e., have closely matched gesture descriptors) may be “ambiguous” gestures. More specifically, it may be very difficult to distinguish between the touch gestures. Touch gestures that are difficult to distinguish may lead to errors or misinterpretation of user intentions, as one touch gesture may easily be interpreted as another touch gesture by a touch gesture recognizer. Usability evaluator 108 may provide an alert when the gesture descriptor for the touch gesture is very similar to an existing touch gesture. The alert to the developer may indicate to the developer that the new touch gesture may be “ambiguous.”

The library of gesture rules may contain a set of guidelines which may indicate similar gesture parameters that may result in ambiguous gestures. Usability evaluator 108 may compare two gestures and evaluate the similarity between the gestures based on the guidelines. As an example, the gesture rules may specify that using two digits moving in a same direction in two different gestures may result in ambiguity between the two different gestures. In such an example, usability evaluator 108 may provide an alert upon detection of two touch gestures which both include two digits moving in a same direction. Dependent on the number of alerts issued for similar touch gestures, usability evaluator 108 may calculate a similarity rating for the touch gesture.

As indicated at 610, the method illustrated in FIG. 6 may include calculating a user rating for the touch gesture. Usability evaluator 108 may conduct real-time user testing of a gesture in similar manner to that described above for independent touch gesture recognizer tests. Based on the results of the user testing, i.e., the users' ability to correctly execute the touch gesture, usability evaluator 108 may determine a user rating for the touch gesture. The user rating may be determined dependent on various metrics. For example, the rating may be determined dependent on a number of times (or a percentage of times) a user was able to correctly execute a touch gesture. As another example, the user rating may be dependent on a user's ability to apply a fine adjustment using a particular touch gesture. In such an example, usability evaluator may monitor an amount of time required for the user to execute the fine adjustment. The usability evaluator may also determine how close the user's result (from the execution of the touch gesture) was to a particular target value for the fine adjustment. Accordingly, usability evaluator 108 may evaluate the user's execution of the touch gesture dependent on the accuracy and precision of the touch gesture. As indicated at 615, the method illustrated in FIG. 6 may include, dependent on the geometry rating, similarity rating, and user rating, calculating a usability rating for the touch gesture. Gesture test system 100 may calculate the usability rating using a variety of methods in different embodiments. As an example, the usability rating may be an average of the geometry rating, similarity rating and user rating of the touch gesture. As another example, the usability rating may be a weighted average of the geometry rating, similarity rating and user rating of the touch gesture, with one or more of the ratings weighted more heavily in the average calculation.

The gesture usability evaluator may also determine a level of accessibility for a touch gesture. Based on a set of heuristics, such as a library of gesture rules, as described above, gesture usability evaluator 108 may determine whether the touch gesture is accessible to, or can be executed by, users with different motor skill levels. For example, the library of gesture rules may contain accessibility rules which apply to users with reduced manual dexterity. Usability evaluator 108 may evaluate a touch gesture against the accessibility rules, using a method similar to that described above, in the gesture rules library to determine whether a touch gesture is accessible to users with reduced manual dexterity.

A gesture test system may be implemented in any authoring application, including but not limited to Adobe® Flash Professional®, Abode® Flash Builder®, or Adobe® Flash Catalyst®. A gesture test system may, for example, be implemented as a stand-alone gesture test application, as a module of a gesture development application such as Adobe® Flash Professional®, Abode® Flash Builder®, or Adobe® Flash Catalyst®, as a plug-in for applications including image editing applications such as Adobe® Flash Professional®, Abode® Flash Builder®, or Adobe® Flash Catalyst®, and/or as a library function or functions that may be called by other applications. Note that Adobe® Flash Professional®, Abode® Flash Builder®, or Adobe® Flash Catalyst® are given as examples, and are not intended to be limiting.

### Example System

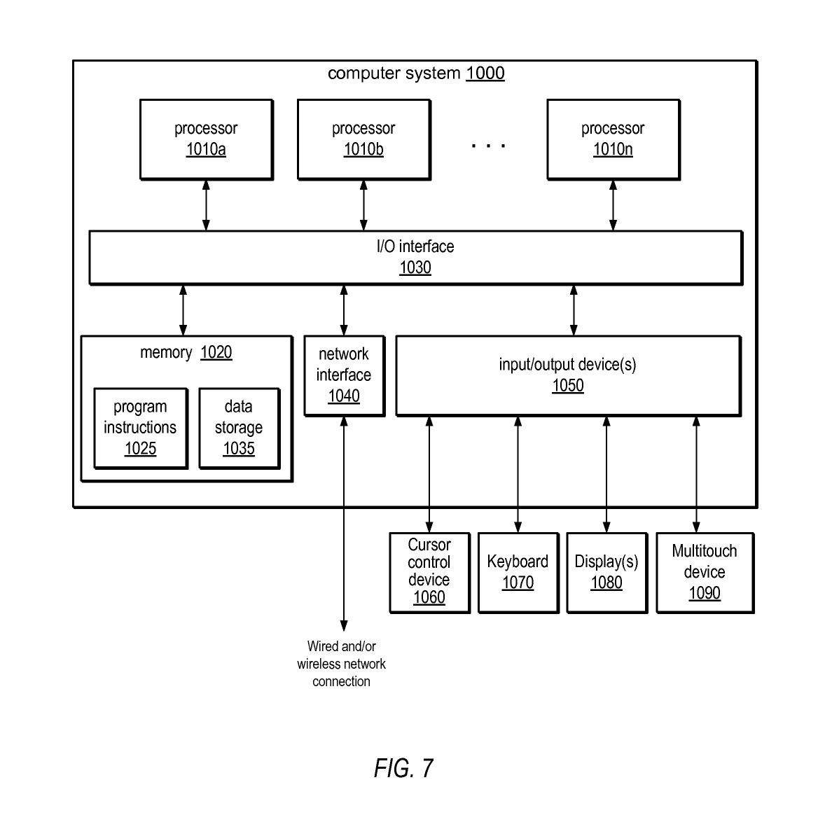

Various components of embodiments of methods as illustrated and described in the accompanying description may be executed on one or more computer systems, which may interact with various other devices. One such computer system is illustrated by FIG. 7. In different embodiments, computer system 1000 may be any of various types of devices, including, but not limited to, a personal computer system, desktop computer, laptop, notebook, or netbook computer, mainframe computer system, handheld computer, touch pad, tablet, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 7, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

1. A method, comprising:
receiving test data which comprises a plurality of gesture event data associated with a respective plurality of gesture events;
sending the test data to a plurality of concurrently operating gesture recognizers, wherein each one of the plurality of gesture recognizers operates independently to respond to a respective particular gesture event data, and wherein each one of the plurality of gesture recognizers responds to a different particular gesture event data;
monitoring the plurality of gesture recognizers to determine which ones of the plurality of gesture recognizers respond to the test data; and
dependent on the response from the plurality of gesture recognizers, determining whether interoperability issues exist for the plurality of gesture recognizers.

2. The method of claim 1, wherein the test data comprises gesture events data recorded in one or more prior, independent tests of one or more of the plurality of gesture recognizers, wherein an independent test of a gesture recognizer comprises:
receiving a plurality of gesture events, wherein the gesture events represent real-time user execution of a gesture, wherein the gesture corresponds to the gesture recognizer;
storing data associated with the gesture events;
sending the gesture events data to the gesture recognizer;
monitoring the gesture recognizer to determine whether the gesture recognizer responds to the gesture events data; and
evaluating the gesture recognizer dependent on the response from the gesture recognizer.

3. The method of claim 1, wherein each one of the plurality of gesture recognizers comprises a different respective rule set which comprises rules for recognizing and interpreting a gesture that corresponds to the one of the plurality of gesture recognizers.

4. The method of claim 1, wherein said determining whether interoperability issues exist for the plurality of gesture recognizers comprises determining whether more than one gesture recognizer responds to test data that represents a particular gesture.

5. The method of claim 1, further comprising:
in response to determining that interoperability issues exist for the plurality of gesture recognizers:
automatically tuning a sensitivity level for one or more of the plurality of gesture recognizers, wherein the sensitivity level specifies a tolerance level for recognizing a corresponding gesture.

6. The method of claim 5, wherein said sending, said monitoring, said determining, and said automatically tuning are repeated until no interoperability issues exist for the plurality of gesture recognizers.

7. The method of claim 1, wherein each gesture event represents a gesture applied to a touch-sensitive surface of an electronic device.

8. A non-transitory computer-readable storage medium storing program instructions executable on a computer to implement a gesture test system that during operation:
receives test data which comprises a plurality of gesture event data associated with a respective plurality of gesture events;
sends the test data to a plurality of concurrently operating gesture recognizers, wherein each one of the plurality of gesture recognizers operates independently to respond to a respective particular gesture event data, and wherein each one of the plurality of gesture recognizers responds to a different particular gesture event data;
monitors the plurality of gesture recognizers to determine which ones of the plurality of gesture recognizers respond to the test data; and
dependent on the response from the plurality of gesture recognizers, determines whether interoperability issues exist for the plurality of gesture recognizers.

9. The non-transitory medium of claim 8, wherein the test data comprises gesture events data recorded in one or more prior, independent tests of one or more of the plurality of gesture recognizers, wherein an independent test of a gesture recognizer comprises:
receiving a plurality of gesture events, wherein the gesture events represent real-time user execution of a gesture, wherein the gesture corresponds to the gesture recognizer;
storing data for the gesture events;
sending the gesture events data to the gesture recognizer;
monitoring the gesture recognizer to determine whether the gesture recognizer responds to the gesture events data; and
evaluating the gesture recognizer dependent on the response from the gesture recognizer.

10. The non-transitory medium of claim 8, wherein each one of the plurality of gesture recognizers comprises a different respective rule set which comprises rules for recognizing and interpreting a gesture that corresponds to the one of the plurality of gesture recognizers.

11. The non-transitory medium of claim 8, wherein said determining whether interoperability issues exist for the plurality of gesture recognizers comprises determining whether more than one gesture recognizer responds to test data that represents a particular gesture.

12. The non-transitory medium of claim 8, wherein, during operation, in response to determining that interoperability issues exist for the plurality of gesture recognizers, the gesture test system automatically tunes a sensitivity level for one or more of the plurality of gesture recognizers, wherein the sensitivity level specifies a tolerance level for recognizing a corresponding gesture.

13. The non-transitory medium of claim 12, wherein, during operation, the gesture test system repeats said sending, said monitoring, said determining, and said automatically tuning until no interoperability issues exist for the plurality of gesture recognizers.

14. The non-transitory medium of claim 8, wherein each gesture event represents a gesture applied to a touch-sensitive surface of an electronic device.

15. A system, comprising:
a memory; and
one or more processors coupled to the memory, wherein the memory stores program instructions executable by the one or more processors to implement a gesture test system that during operation:
receives test data which comprises a plurality of gesture event data associated with a respective plurality of gesture events;
sends the test data to a plurality of concurrently operating gesture recognizers, wherein each one of the plurality of gesture recognizers operates independently to respond to a respective particular gesture event data, and wherein each one of the plurality of gesture recognizers responds to a different particular gesture event data;
monitors the plurality of gesture recognizers to determine which ones of the plurality of gesture recognizers respond to the test data; and
dependent on the response from the plurality of gesture recognizers, determines whether interoperability issues exist for the plurality of gesture recognizers.

16. The system of claim 15, wherein the test data comprises gesture events data recorded in one or more prior, independent tests of one or more of the plurality of gesture recognizers, wherein an independent test of a gesture recognizer comprises:
receiving a plurality of gesture events, wherein the gesture events represent real-time user execution of a gesture, wherein the gesture corresponds to the gesture recognizer;
storing data for the gesture events;
sending the gesture events data to the gesture recognizer;
monitoring the gesture recognizer to determine whether the gesture recognizer responds to the gesture events data; and
evaluating the gesture recognizer dependent on the response from the gesture recognizer.

17. The system of claim 15, wherein each one of the plurality of gesture recognizers comprises a different respective rule set which comprises rules for recognizing and interpreting a gesture that corresponds to the one of the plurality of gesture recognizers.

18. The system of claim 15, wherein said determining whether interoperability issues exist for the plurality of gesture recognizers comprises determining whether more than one gesture recognizer responds to test data that represents a particular gesture.

19. The system of claim 15, wherein, during operation, in response to determining that interoperability issues exist for the plurality of gesture recognizers, the gesture test system automatically tunes a sensitivity level for one or more of the plurality of gesture recognizers, wherein the sensitivity level specifies a tolerance level for recognizing a corresponding gesture.

20. The system of claim 19, wherein, during operation, the gesture test system repeats said sending, said monitoring, said determining, and said automatically tuning until no interoperability issues exist for the plurality of gesture recognizers.
